(19) United States
(12) Patent Application Publication
(10) Pub. No.: US 2014/0222950 A1
(43) Pub. Date: Aug. 7, 2014

(54) Predictive Mobile Map Download

(71) Applicant: NAVTEQ B.V., Veldhoven (NL)

(72) Inventor: Dietmar Rabel, Frankfurt am Main (DE)

(73) Assignee: NAVTEQ B.V., Veldhoven (NL)

(21) Appl. No.: 13/758,035

(22) Filed: Feb. 4, 2013

(51) Int. Cl. H04L 29/08

(52) U.S. Cl. CPC H04L 29/08117
USPC 709/217

(57) ABSTRACT

In one embodiment, a mobile device is operable to predict a future location of the mobile device by analyzing a memory for indicators of the future location and identifying a predicted location of the mobile device using the indicators. The mobile device is further operable to request or download geographic data corresponding to the predicted location of the mobile device. Some embodiments may provide for the recognition of a preferred network to allow the download of the geographic data from a server.

### FIELD

The following disclosure relates to map and navigation related applications, and more specifically to predicting or anticipating locations in a map or navigation related application.

### BACKGROUND

Map and navigation systems provide end users with various map and navigation related functions and features. To provide these functions and features, map and navigations systems use a large amount of geographic data. Generally this geographic data is stored locally on a mobile device. As many mobile devices have a limited memory capacity, only the geographic region limited to an area of main interest (e.g. home city or home state) is stored locally. Geographic data for additional geographic regions may be downloaded incrementally or refreshed as required.

Determining geographic data to be downloaded happens several ways. A system may identify a current direction of travel and a current geographic position to predict the next adjacent geographic region to be downloaded during a trip. Systems can also download geographic data correlating to a predetermined route of travel.

Network data connections are often needed to download additional geographic data or update already downloaded data with the latest changes corresponding to geographic regions. These network data connections may have associated fees for data download volumes, and these fees can be expensive. This is often the case when a user is traveling out of a home geographic region, and no longer has access to data on a preferred WiFi network or a home mobile phone network.

### SUMMARY

In an embodiment, a method is provided for predicting a future location of a mobile device and downloading geographic data corresponding to the predicted future location. The prediction is performed by analyzing a memory for indicators of the predicted future location, and identifying the predicted location using the indicators. The embodiment may provide that the indicators of the predicted future location may be an e-mail, a meeting request, a travel itinerary, a flight confirmation, a hotel confirmation, or a rental car confirmation. In another embodiment, the method directs a download of the geographic data corresponding to the predicted future location only when the mobile device is connected to a preferred data network or data network category.

In another embodiment, an apparatus is operable to determine an upcoming travel instance, determine a travel location associated with the travel instance, determine a travel region associated with the travel location, and download geographic data to a mobile device corresponding to the travel region. An embodiment may provide for determining multiple upcoming travel instances and travel locations. The multiple upcoming travel instances may have an associated priority of download. Another embodiment may also determine a secondary travel location for a travel instance, as well as a geographic corridor between a first location and a second location of a travel instance.

In another embodiment, an apparatus is operable to store geographic data and data indicating a future travel instance, determine a future travel instance that includes a travel location from the data indicating a future travel instance, and receive geographic data corresponding to the future travel location.

### BRIEF DESCRIPTION OF THE DRAWINGS

Exemplary embodiments of the present invention are described herein with reference to the following drawings.

FIG. 1 illustrates an exemplary map and navigation system.

FIG. 2 illustrates an exemplary mobile device of the map and navigation system of FIG. 1.

FIG. 3 illustrates an exemplary server of the map and navigation system of FIG. 1.

FIG. 4 illustrates an example flowchart for predicting locations and downloading map data.

FIG. 5 illustrates an example flowchart for determining a travel instance and downloading map data.

FIG. 6 illustrates an example of mobile network regional areas and boundaries.

FIG. 7 illustrates an example of a travel instance.

### DETAILED DESCRIPTION

A user that travels frequently may plan in advance to download geographic data before the user travels so that the user does not consume a high volume of data when roaming out of home or preferred networks. If a user does not download the geographic data in advance of a trip out of a home geographic region, the user may not be able to use the map and navigation systems during that trip without incurring the often severe costs associated with out of network data usage. A device that has downloaded data in advance of a trip out of a home geographic region may function to provide geographic data independent of a connection to a data network while the trip is in progress.

Travel information may be available electronically that can be used for predicting a future location of a mobile device user. This electronic information takes the form of e-mailed itineraries, hotel confirmations, calendar entries indicating meetings located away from a home office, and many other forms. Any of this travel information may be contained on a particular mobile device.

The following embodiments include a system and method for searching data on a mobile device, or a server, for data regarding any planned travel activities. The system initiates an advance map download when the mobile device is connected to a preferred or inexpensive data connection. For example, when a user books a flight to a city, possibly Toronto, the user receives a confirmation e-mail for this flight. The confirmation e-mail is automatically detected and the mobile device determines that the mobile device will be in Toronto in a few weeks. Hence, the map database for Toronto is downloaded in advance, or automatically refreshed if the map database is already on the device.

E-mails, calendar entries, or any other form of data may be used as sources or indicators of travel, or of a future mobile device location. Further, more specific locations for which the map database may be downloaded can be detected or identified by referencing an address book stored on the mobile device for the addresses of people with whom meetings are scheduled during a travel instance. For example, a user's flight may be to Chicago but the user may have several meetings with contacts having addresses indicating a location 100 km west of Chicago. This can be detected automatically and the exact download area may be defined based on this detection mechanism. For these more specific locations, more specific geographic data can also be downloaded, which may include specific points of interest in a close proximity to the specific address, or other map data such as a transit schedule or business operational hours, which might be of interest to someone traveling to the specific location. The people the user plans to meet during a travel instance may also be detected by monitoring social network usage, or increased e-mail activity to certain contacts before a travel instance begins.

Embodiments may provide for the automation of the travel detection and the automated download of map data for a target region in advance of such travel using a preferred or inexpensive data connection.

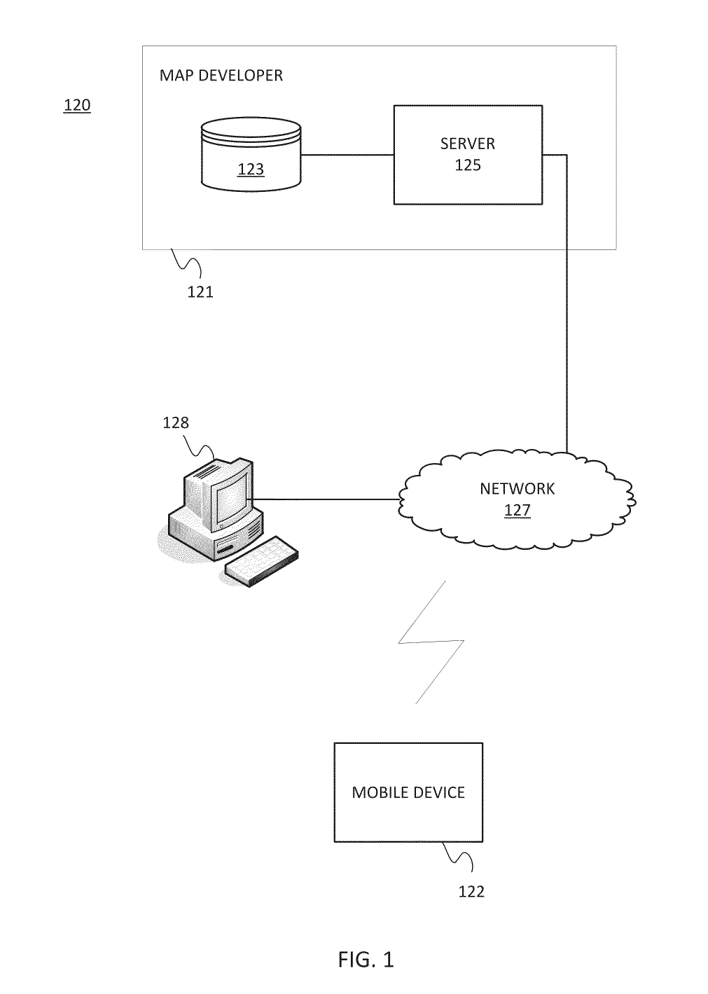

FIG. 1 illustrates an exemplary map and navigation system 120. The map and navigation system 120 includes a map developer system 121, a mobile device 122, a workstation 128, and a network 127. Additional, different, or fewer components may be provided. For example, many mobile devices 122 and/or workstations 128 may connect with the network 127.

The developer system 121 includes a server 125 and a database 123. The optional workstation 128 is a general purpose computer including programming specialized for the following embodiments. The workstation 128 includes at least a memory, a processor, and a communication interface. The developer system 121 may include computer systems and networks of a system operator such as NAVTEQ or Nokia Corporation. The geographic database 123 may be partially or completely stored in the mobile device 122.

The developer system 121, the workstation 128, and the mobile device 122 are coupled with the network 127. The phrase “coupled with” is defined to mean directly connected to or indirectly connected through one or more intermediate components. Such intermediate components may include hardware and/or software-based components. The mobile device 122 is a smart phone, a mobile phone, a personal digital assistant (“PDA”), a tablet computer, a notebook computer, a personal navigation device (“PND”), a portable navigation device, an in-vehicle or in-dash navigation device, and/or any other known or later developed mobile device.

The mobile device 122 includes one or more detectors or sensors as a positioning system built or embedded into or within the interior of the mobile device 122. Alternatively, the mobile device 122 uses communications signals for position determination. The mobile device 122 receives location data from the positioning system. The server 125 may receive sensor data configured to describe a position of a mobile device, or a controller of the mobile device 122 may receive the sensor data from the positioning system of the mobile device 122.

The database 123 includes geographic data used for map and navigation-related applications. The geographic data may include data representing a road network including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the geographic data. The geographic data may also represent points-of-interests. The points-of-interest may include gasoline stations, hotels, restaurants, museums, stadiums, offices, automobile dealerships, auto repair shops, buildings, stores, statues, monuments, or geographic landmarks. The data representing points-of-interest indicate the location of the point-of-interest, including how to access the point-of-interest using the road network (or pedestrian network), and various features or attributes of the point-of-interest, including hours of operation, telephone number, types of products and services available at the point-of-interest, address, and so on. Geographic data may also include transit system data such as transit schedules or fares, business information such as hours of operation, or any other data regarding a predicted future location.

The network 127 may include wired networks, wireless networks, or combinations thereof. The wireless network may be a cellular telephone network, an 802.11 (“WiFi”), 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols. The network 127 may be a preferred network. The preferred network may be determined by a user or may be determined automatically. The preferred network may be determined using costs associated with downloading data, data download or baud rates, network operators, network categories such as WiFi or WiMax, or any other network feature.

An embodiment may provide that a mobile device 122 is operable to predict a future location of the mobile device 122 by analyzing content stored on the mobile device 122, or the server 121, for indicators of a predicted future location, and identifying a predicted location of the mobile device 122 using the indicators of a predicted future location. The mobile device 122 is further operable to communicate with a server 125 via a network 127 to download geographic data relating to the predicted future location of the mobile device 122 from the geographic database 123 located on the server 121.

Indicators of a predicted location may involve many different forms of data. Indicators may exist in the form of internet search data. For example, a user may have recently searched for Toronto, Canada using a search engine, and the search data may indicate a predicted location. Also, a frequency of searches for particular topics may be used to indicate a predicted location. A collection of searches for geographically related subjects may also be used to indicate a predicted location. For example, a user may search for “Soldier Field” and/or “Wrigley Field,” the data for which may indicate that Chicago, Ill. is a predicted location. Specific indicators may be used independently to determine a predicted location, or in combination with other indicators.

As such, indicators may take other forms, as well as fall into distinguishable categories, such as internet search data, an e-mail, a meeting request, a calendar entry, a contact listing, a record of previous locations, social media data, or any category of data that may indicate a predicted position.

For example, data in an e-mail category may be analyzed for content indicating a predicted location. This content could take the form of airport codes, location names, specific words like “trip” or “flight”, or even frequency of contact with a contact. The analysis of data in a contact listing category may be different than the content analyzed in an e-mail category. For example, data in a contact listing category may be analyzed for a specific location of a contact to use as a predicted location. Data in a contact listing category may also be analyzed for dates such as birthdays or anniversaries that may indicate a predicted travel instance involving a predicted travel location of the contact's associated address. In another embodiment, data in a social media category may be analyzed for content and intended recipient of content. For example, a user may direct a phrase such as “I can't wait to see you!” to a recipient using a social network. The location of the recipient may be determined from associated social network data, and the location of the recipient may then be determined to be a predicted location. Indicator categories may be used independently, or in combination.

A navigation request may be received for a point-of-interest associated with a future location while the mobile device 122 is not connected to a preferred network. The navigation request may be received by the mobile device 122 while the mobile device 122 is located within a home geographic region, or while a mobile device 122 located outside of a home geographic region. The navigation request may specify the name of the point-of-interest, a category of the point-of-interest, or the specific geographic location. The navigation request may be received at the mobile device 122, for example, from a user interface or input device. The navigation request may be received at the server 125 from the mobile device 122. The navigation request may be used to provide routing as described below. If the appropriate geographic data was downloaded to the mobile device 122 previously when the mobile device 122 was connected to a preferred network, the navigation request may be fulfilled without a current connection to network 127.

In an embodiment, routing may be provided between predicted future locations of the mobile device 122, or to a point of interest. The selection of the point of interest may be based, at least in part, on the predicted future locations of the mobile device 122.

The computing resources for determining a future location of the mobile device 122 may be divided between the server 125 and the mobile device 122. In some embodiments, the server 125 performs a majority of the processing (“server-based embodiments”). In other embodiments, the mobile device 122 or the workstation 128 performs a majority of the processing (“endpoint-based embodiments”). In addition, the processing is divided substantially evenly between the server 125 and the mobile device 122 or workstation 128 (“hybrid embodiments”).

An endpoint based embodiment may provide that a predicted future location of the mobile device 122 is determined using only data stored on the mobile device 122. A server-based embodiment may provide that a predicted future location of the mobile device 122 is determined using only data stored on a server 125. A hybrid embodiment may provide that a predicted future location of the mobile device 122 is determined using data stored on the mobile device 122 or the server 125 or both.

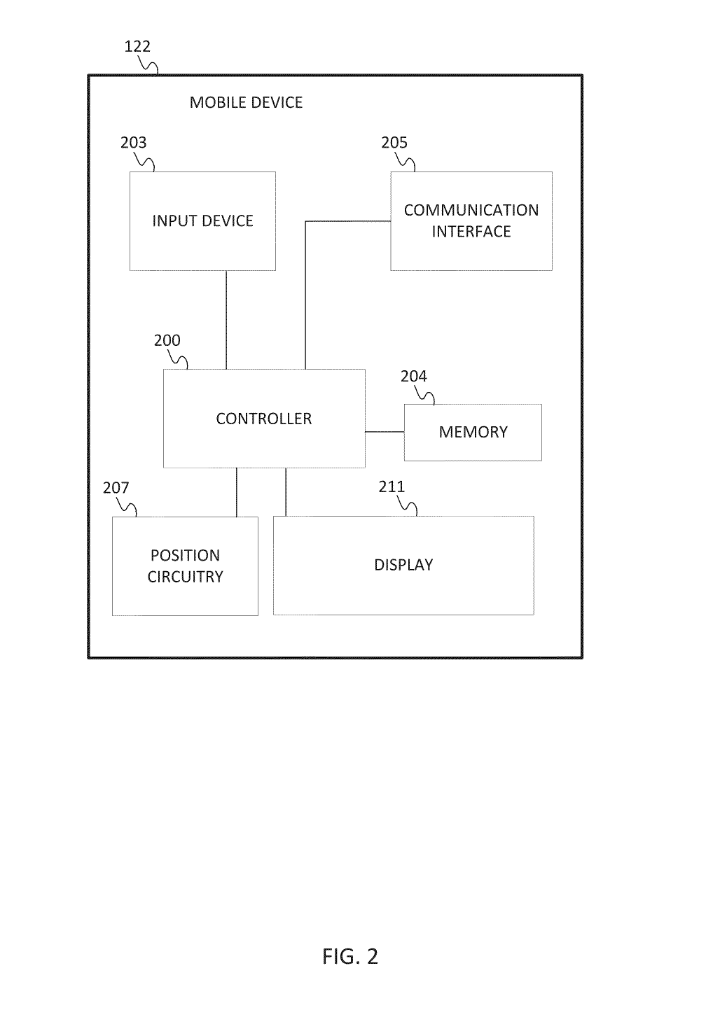

FIG. 2 illustrates an exemplary mobile device 122 of the map and navigation system of FIG. 1. The mobile device 122 may be referred to as a navigation device. The mobile device 122 includes a controller 200, a memory 204, an input device 203, a communication interface 205, position circuitry 207, and a display 211. Additional, different, or fewer components are possible for the mobile device 122. The workstation 128 may include at least a memory and processor and may be substituted for the mobile device 122 in following endpoint-based embodiments. In following endpoint-based embodiments, the mobile device 122 or the workstation 128 performs a majority of the processing.

The memory 204 may include geographic data, indicators of a predicted location, or both. The indicators of a future location may include an e-mail, a meeting request, a travel itinerary, a flight confirmation, a hotel confirmation, a rental car confirmation, or any other data indicating a future location.

In an embodiment, the controller 200 is configured to predict at least one future location of the mobile device 122 by analyzing the memory 204 for indicators of a future location and identifying at least one predicted location of the mobile device 122 using the indicators. The controller 200 is further configured to connect to a network 127 using the communication interface 205 to download geographic data corresponding to the at least one predicted location of the mobile device 122 from the server 121.

An embodiment may provide that predicting at least one future location of the mobile device 122 involves the controller 200 determining an upcoming travel instance, and determining at least one travel location associated with the travel instance. Further embodiments may provide that the travel location is the predicted location.

The network 127 may be a preferred network or network category, and that the communication interface 205 may only download geographic data corresponding to the at least one predicted location of the mobile device 122 from the server 121 while connected to the preferred network. A preferred network or network category may include home region mobile telephone data networks, WiFi networks, or any other type of network including networks with inexpensive data download rates.

The controller 200 may also analyze the memory 204 to identify secondary travel locations related to an upcoming travel instance. For example, a travel instance may be identified by a flight itinerary contained in an e-mail, and an airport may be identified as a travel location. A different e-mail may contain a hotel confirmation that indicates a secondary location of a hotel associated with the confirmation. This travel instance may then include a primary airport travel location and a secondary hotel travel location.

Further, an embodiment may provide that the controller 200 detects a predicted mode of transportation between the travel location and the secondary travel location. For example, an e-mail containing a rental car reservation may be identified. The controller 200 may detect from the rental car reservation that the mode of transportation between the travel location and the secondary travel location is an automobile. Using the mode of transportation detection, the controller 200 may determine a travel corridor between the travel location and the secondary travel location, and download geographic data related to that travel corridor. Alternatively, the controller 200 may detect that the mode of transportation between the travel location and the secondary travel location is a transit system, and that the appropriate related geographic data may include a transit system schedule, transit system fares, or other transit system data.

An embodiment may also provide that there are multiple determined travel locations. The controller 200 may prioritize the downloading of the geographic data corresponding to the determined travel locations. The geographic data may be prioritized based on the size of the projected download associated with the corresponding data. In an embodiment the travel locations may be associated with travel dates. The controller 200 may prioritize the downloading of geographic data based on the associated travel dates. In one embodiment the geographic data may be prioritized chronologically based on the associated travel dates.

The positioning circuitry 207, which is an example of a positioning system, is configured to determine a geographic position of the mobile device 122. The positioning circuitry 207 may include suitable sensing devices that measure the traveling distance, speed, direction, and so on, of the mobile device 122. The positioning system may also include a receiver and correlation chip to obtain a global positioning system (“GPS”) signal. Alternatively or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 207 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 207 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The positioning circuitry 207 may be used to determine when the mobile device 122 is approaching a geographic boundary that may indicate that the mobile device 122 is leaving the range of a preferred network. This occurrence may trigger the controller 200 to initiate the execution of geographic data downloads corresponding to predicted future locations. For example, the positioning circuitry 207 may indicate that the mobile device 122 is traveling from Buffalo, N.Y. to Toronto, Canada, and is approaching the Canadian border. The Canadian border may be a geographic boundary of a preferred mobile telephone data network, recognized by the controller 200. This occurrence may trigger the download of geographic data corresponding to Toronto, Canada while the mobile device is still connected to a preferred mobile telephone data network. This occurrence may also trigger the download of geographic data relating to a travel corridor between Buffalo, N.Y. and Toronto, Canada.

The input device 203 may be one or more buttons, keypad, keyboard, mouse, stylist pen, trackball, rocker switch, touch pad, voice recognition circuit, or other device or component for inputting data to the mobile device 122. The input device 203 and the display 211 may be combined as a touch screen, which may be capacitive or resistive. The display 211 may be a liquid crystal display (LCD) panel, light emitting diode (LED) screen, thin film transistor screen, or another type of display. The input device 203 may allow a user to respond to a prompt for information. For example, a user may be prompted to input or select a preferred network. A user may also be prompted for input to clarify a predicted location or travel instance.

Another embodiment may provide that the memory 204 is configured to store geographic data indicating a future travel instance. Also, the controller 200 is configured to determine a future travel instance from the data indicating a future travel instance. The controller 200 may be further configured to determine at least one travel location associated with the travel instance. Further, the communication interface 205 is configured to receive geographic data corresponding to the future travel location.

An embodiment may provide that the data indicating a future travel instance is an e-mail, a meeting request, a travel itinerary, a flight confirmation, a hotel confirmation, or a rental car confirmation. Any other data may be used for indicating the future travel instance as well, such as social media entries, search engine searches, telephone contact records, contact e-mail frequencies, historical travel records indicating a travel cycle, or any other data indicating a travel instance.

An embodiment may also provide that the processor 300 may allow geographic data corresponding to the future travel location to be downloaded by the communication interface 305 only when the network 127 is a network of a preferred network category. A preferred network category may be a cellular telephone network, a WiMax network, a WiFi network, or any other type of network category. Preferred network categories may be input by a user, or automatically generated. An automatically generated preferred network category may be determined based on an associated cost of data received from a network belonging to the network category.

Another embodiment may indicate that the processor 300 is configured to identify a secondary travel location related to the upcoming travel location, and that the communication interface 305 is further configured to receive geographic data related to the secondary travel location.

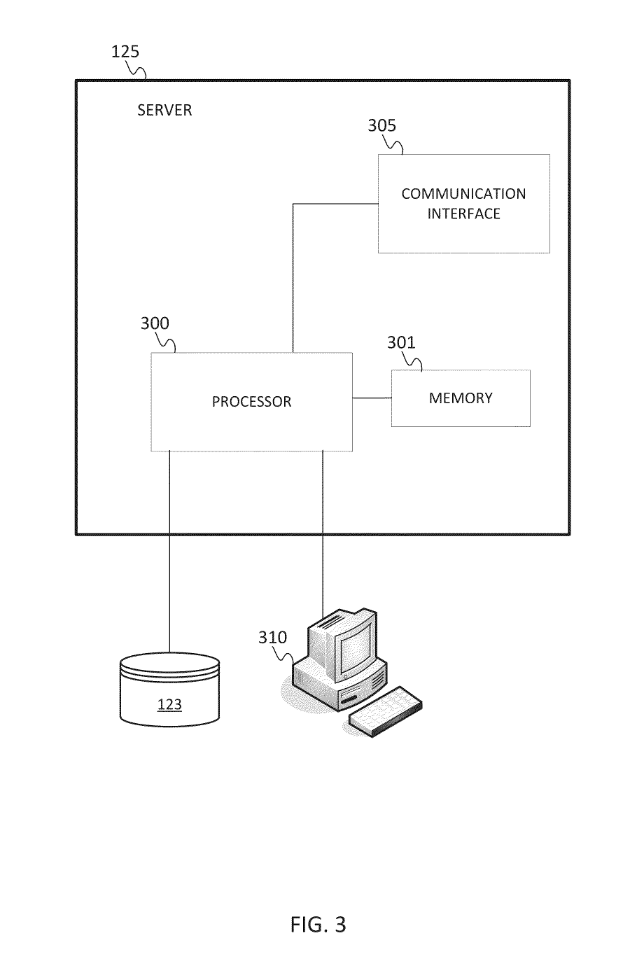

FIG. 3 illustrates an exemplary server 125 of the map and navigation system of FIG. 1. The server 125 includes a processor 300, a communication interface 305, and a memory 301. The server 125 may be coupled to a database 123 and a workstation 310. The database 123 may be a geographic database as discussed above. The workstation 310 may be used as an input device for the server 125. In addition, the communication interface 305 is an input device for the server 125. The communication interface 305 receives data indicative of use inputs made via the workstation 128 or the mobile device 122.

The memory 301 may be configured to store geographic data, indicators of a future travel location, or both. The memory 301 may also be configured to store other types of data to be used with a map and navigation system.

The processor 300 may be configured to predict a future location of a mobile device 122, and send geographic data corresponding to the predicted location to the mobile device 122 using the communication interface 305. The processor 300 may predict a future location of a mobile device 122 by analyzing indicators of a future location stored on the memory 301, and identifying at least one predicted location of the mobile device 122 using the indicators.

The communication interface 305 is configured to receive data indicative of a request for geographic data corresponding to a predicted location of a mobile device 122. The processor 300 is configured to identify geographic data corresponding to a predicted location of a mobile device 122. The communication interface 305 is configured to send the geographic data to the mobile device 122.

The communication interface 305 may also be configured to communicate indicators of a future travel location to the mobile device 122.

A hybrid embodiment may provide that predicting a future location of the mobile device 122 may be performed by the controller 200 and/or processor 300 of either the mobile device 122 or the server 125, or any combination thereof. Further, an embodiment may provide that indicators of a future location are stored on the memory 301/204 of the mobile device 122 or the server 125, or both.

The controller 200 and/or processor 300 may include a general processor, digital signal processor, an application specific integrated circuit (ASIC), field programmable gate array (FPGA), analog circuit, digital circuit, combinations thereof, or other now known or later developed processor. The controller 200 and/or processor 300 may be a single device or combinations of devices, such as associated with a network, distributed processing, or cloud computing.

The memory 204 and/or memory 301 may be a volatile memory or a non-volatile memory. The memory 204 and/or memory 301 may include one or more of a read only memory (ROM), random access memory (RAM), a flash memory, an electronic erasable program read only memory (EEPROM), or other type of memory. The memory 204 and/or memory 301 may be removable from the mobile device 100, such as a secure digital (SD) memory card.

The communication interface 205 and/or communication interface 305 may include any operable connection. An operable connection may be one in which signals, physical communications, and/or logical communications may be sent and/or received. An operable connection may include a physical interface, an electrical interface, and/or a data interface. The communication interface 205 and/or communication interface 305 provides for wireless and/or wired communications in any now known or later developed format.

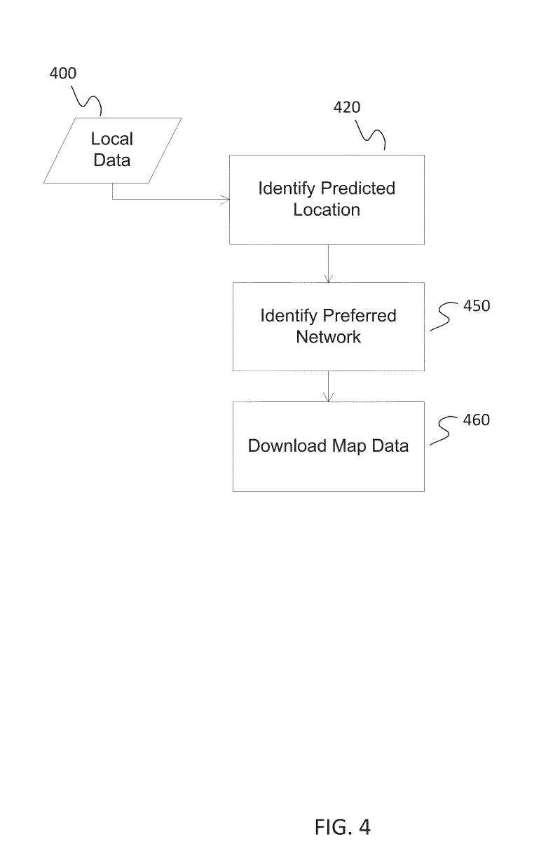

FIG. 4 illustrates an example flowchart for predicting locations and downloading map data.

At act 420 a location is predicted using local data 400. The local data 400 may include an e-mail, a meeting request, a travel itinerary, a flight confirmation, a hotel confirmation, or a rental car confirmation. Any other data may be used for predicting locations as well, such as social media entries, search engine searches, telephone contact records, contact e-mail frequencies, historical travel records indicating a travel cycle, or any other data indicating a travel instance. A user may also be prompted for input to clarify a predicted location.

At act 450 a preferred network connection is identified. The preferred network connection may be determined by a user or may be determined automatically. A preferred network may be determined using costs associated with downloading data, data download or baud rates, network operators, network categories such as WiFi or WiMax, or any other network feature. A user may also be prompted for input to acknowledge a network connection as a preferred network.

At act 460 geographic data corresponding to the predicted location is downloaded from a server using the identified preferred network connection. The geographic data may include points of interest, geographic features, road data, navigation data, transit system data such as schedules or fares, local business information, or any other information related to the predicted location.

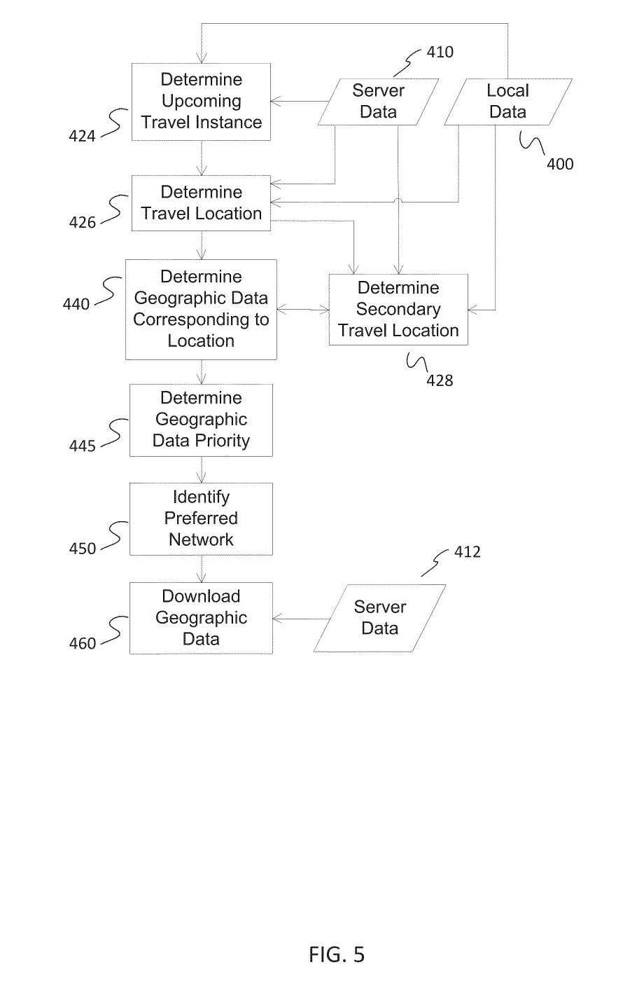

FIG. 5 illustrates an example flowchart for determining a travel instance and downloading map data.

At act 424 an upcoming travel instance is determined using server data 410, local data 400, or a combination of both. The server data 410 and the local data 400 may include an e-mail, a meeting request, a travel itinerary, a flight confirmation, a hotel confirmation, or a rental car confirmation. A travel instance may also be determined using a combination of sources. Any other data may be used for predicting locations as well, such as social media entries, search engine searches, telephone contact records, contact e-mail frequencies, historical travel records indicating a travel cycle, or any other data indicating a travel instance. A travel instance may also have associated travel instance dates. A user may also be prompted for input to clarify an upcoming travel instance. Multiple travel instances may be determined.

At act 426 a travel location is determined using the travel instance determined in act 424, server data 410, local data 400, or any combination of these. Multiple travel locations may be determined for a travel instance. A travel location may also have an associated travel date. A user may also be prompted for input to clarify a travel location.

At act 428 a secondary travel location may be determined using the travel location determined in act 426, server data 410, local data 400, or any combination of these. The secondary travel location may be determined automatically. For example, if the Chicago O'Hare International Airport is determined to be the travel location, Chicago, Ill. may be determined a secondary travel location. Also, other data may indicate a secondary travel location. For example, a calendar entry may indicate that there is a meeting in Rockford, Ill. which may indicate that Rockford, Ill. is a secondary travel location. Multiple secondary travel locations may be determined for a travel instance. A user may also be prompted for input to clarify or enter any secondary travel locations.

At act 440 geographic data corresponding to determined travel locations. The geographic data may include points of interest, geographic features, road data, navigation data, transit system data such as schedules or fares, local business information, or any other information related to the predicted location. Geographic data for geographic regions around or surrounding the determined travel locations may be identified. The geographic regions may be circular with a constant radius, rectangular, or any shape determined by the geographic data existing for the identified travel locations, or capacity limitations of the data storage available for a mobile device. Geographic data corresponding to secondary travel locations may also be determined.

Geographic data relating to a geographic travel corridor between the determined travel location and determined secondary travel locations may also be determined. A travel corridor may be determined using an identified or predicted mode of transit between the primary travel location and the secondary travel location. For example, a mobile device or server may identify that the most common mode of transportation between O'Hare International Airport and the city center of Chicago, Ill. is Chicago's transit system. In this case the related travel corridor information may include a transit system map, navigations directions between the travel location and the secondary travel location, a transit system schedule, transit system fare information, or any other information related to the determined mode of transit.

In an embodiment, a rental car reservation may indicate that the mode of transit between the travel location and the secondary travel location is an automobile. In this case, geographic data including road data for a region surrounding an estimated route between the travel location and the secondary travel location may be determined. The geographic data may also include data corresponding to geographic regions surrounding the estimated route between the travel location and the secondary travel location. The geographic data may also include a list of directions or points of interest along the estimated route. The geographic data may also include a primary route and alternate routes.

If multiple travel instances or travel locations are determined a download priority may be assigned to the determined geographic data at act 445. A download priority may be required or preferred when a mobile device contains a limited data storage capacity, and there are multiple travel instances identified. In situations like this, a phone may not contain enough storage capacity to download geographic data for all of the determine travel instances or travel locations. The priority may be based on dates associated with the travel instances or travel locations. For example, the geographic data may be downloaded chronologically for upcoming travel instances based on determined travel dates. A user may also be prompted for input to clarify or determine the geographic data priority.

At act 450 a preferred network connection is identified. The preferred network may be pre-determined by a user or may be determined automatically. The preferred network may be determined using costs associated with downloading data, data download or baud rates, network operators, network categories such as WiFi or WiMax, or any other network feature. A user may also be prompted for input to clarify or determine a preferred network. An embodiment may provide that a preferred network connection may not be identified, and instead a user may be prompted for approval of a geographic data download.

At act 460 determined geographic data is downloaded from the server data 412 using a network. The network may be a preferred network.

The download of the geographic data in act 460 may be required prior to a defined time period before the travel location date or the travel instance dates. For example, the geographic data may be required to be downloaded no less than 24 hours prior to a determined travel location date, or travel instance dates. In another embodiment, a time period window may be provided for the download of geographic data corresponding to a travel location. For example, downloading of geographic data may be allowed in the time period window of two weeks to one day prior to the determined travel location date. The download of geographic data in act 460 may also occur prior to the commencement of a travel instance.

The download of the geographic data in act 460 may be required before a geographic threshold outside of the predicted location is reached. For example, it may be determined that a current location of a traveler is 100 miles from a travel location determined in act 426. In this instance a geographic threshold may be 30 miles from a travel location, and geographic data for the determine travel location is downloaded before the traveler is closer than 30 miles from the travel location. The geographic boundary may also trigger the downloading of geographic data. For example, the downloading of geographic data may be triggered by crossing the 30 mile threshold from the travel location. Also, downloading the geographic data may only be allowed in a threshold window containing maximum and minimum thresholds for downloading geographic data. For example, downloading geographic data may be permitted in the threshold window between 100 miles from the travel location and 30 miles from the travel location. The geographic boundary may also be a geographic border, such as the Canadian border. For example, if a travel location determined in act 426 is Toronto, Canada, a requirement may be in place indicating that geographic data correlating to Toronto, Canada be downloaded prior to crossing the Canadian border.

The download of the geographic data in act 460 may also occur when a traveler is not in transit. For example, a car containing a mobile navigation device may download the geographic data determined to correspond to the travel location while the car is parked in a garage, and the mobile navigation device is connected to a home WiFi network, which may be a preferred network. In another embodiment, a traveler's mobile phone may be connected to a preferred hotel WiFi network, and the download of the geographic data corresponding to the travel location may be downloaded while the traveler is in the hotel.

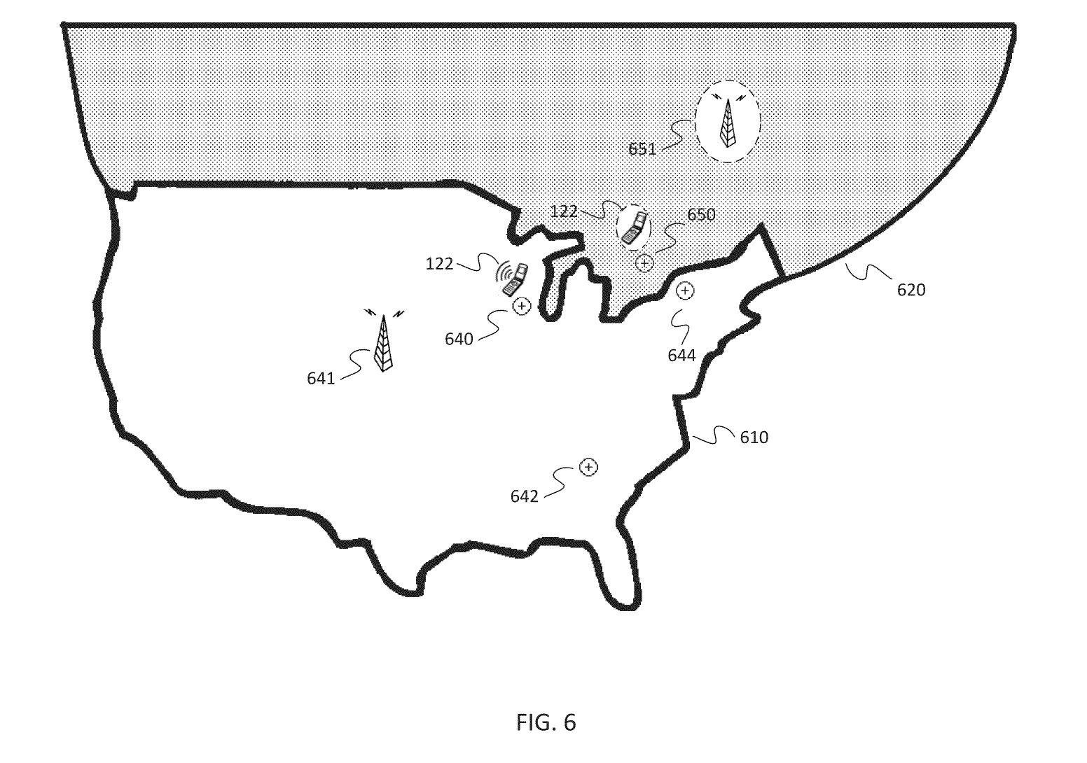

FIG. 6 illustrates an example of mobile data network regional areas and boundaries. A mobile device 122 may be connected to a home region data network 641 bounded by a geographic boundary 610 when the mobile device 122 is located in a home geographic region 640. The cost associated with downloading data from a home region data network 641 may be free, or moderately priced.

When a mobile device 122 is located in a travel location 650, the mobile device is no longer able to connect to the home region data network 641. The availability of preferred networks in the travel location 650 may be limited, and the data network option may be a roaming data network 651 bounded by geographic boundary 620. The cost associated with downloading data when connected to the roaming data network 651 may be considerably higher than the cost associated with downloading data from the home region data network 641.

To avoid higher rates for data downloads of geographic data, a mobile device 122 may be configured to determine an upcoming travel instance that includes travel location 650. The mobile device 122 may be configured to determine a travel region associated with travel location 650. The mobile device 122 may be further configured to download or update geographic data corresponding to the determined travel region associated with the travel location 650. The mobile device 122 may also be configured to perform this download while connected to an identified preferred network, such as the home region data network 641. An embodiment may provide that determining a travel location may be performed using only data stored on the mobile device 122. By downloading or updating geographic data corresponding to the determined travel region prior to traveling to travel location 650, the mobile device 122 may operate to provide the geographic data to a user independent of any connection to a data network.

A preferred network may also be a home WiFi network which may not be available for a determined upcoming travel instance involving travel location 642. In such an embodiment, the home region data network 641 may not be a preferred network, and the preferred network may belong to a network category such as WiFi networks. In this embodiment, the mobile device 122 may need to identify and download geographic data corresponding to travel location 642 prior to the commencement of the indicated travel instance to ensure the functionality of the map and navigation capabilities of the mobile device 122. For example, the geographic data corresponding to travel location 642 may be downloaded while connected to the home WiFi network, which belongs to the preferred network category of WiFi.

Also, another embodiment may determine that the mobile device is in transit from location 644 to travel location 650. This determination may indicate a travel instance, and geographic data relating to travel location 650 may be downloaded using the home region data network 641 prior to crossing geographic boundary 610. Another embodiment may trigger the download of geographic data when a threshold of geographic boundary 610 is reached. For example, the geographic data corresponding to travel location 650 may be downloaded if it is determined that the mobile device 122 is less than one mile from geographic boundary 610.

A mode of transit may be detected between location 644 and travel location 650 using velocity data, position data, and map data. For example, velocity data may be developed using position data over time, and correlating velocity and current position data with map data may indicate that the mobile device is traveling at a velocity typical for an automobile, at a position that indicates a particular road that is being followed. The mode of transit may similarly be determined to be a train, boat, bicycle, pedestrian, or any other operable means of transit between locations. The mode of transport may also be detected using other data such as a train ticket confirmation or a rental car reservation.

Geographic data corresponding to a travel corridor between location 644 and travel location 650 may be determined. The determined geographic data may be, at least partially, determined using the detected mode of transport. For example, road data for a travel corridor between location 644 and travel location 650 may be determined to be pertinent for a detected automotive mode of transport. Train schedules or bicycle path maps may be determined pertinent for other modes of transport.

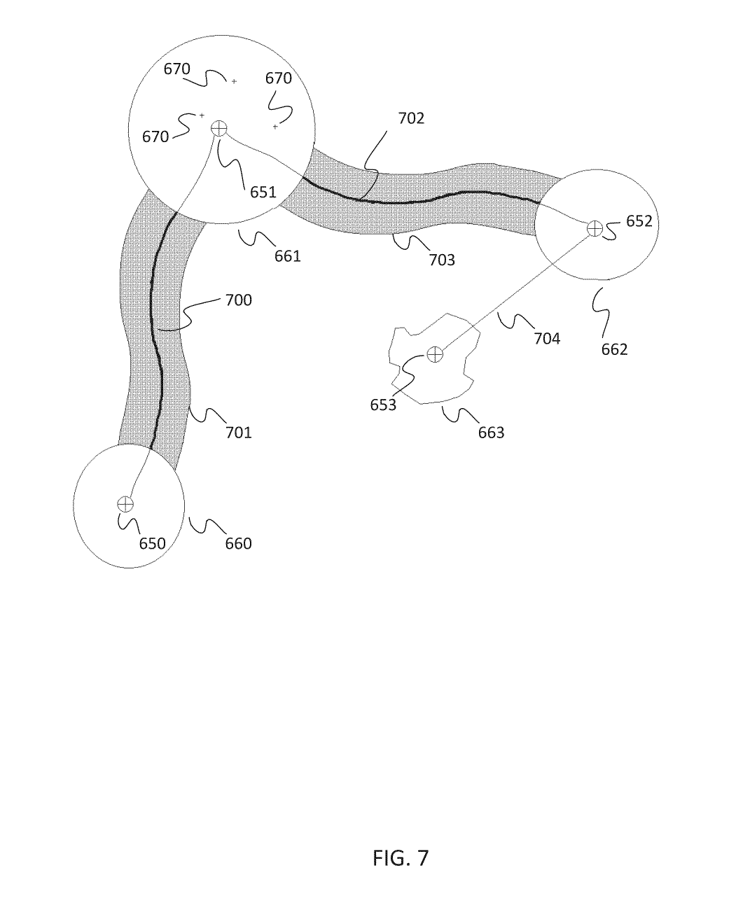

FIG. 7 illustrates an example of a travel instance that involves travel location 650. Travel location 650 is surrounded by travel region 660. Geographic data corresponding to travel location 650 may be bounded by travel region 660. Travel regions may be any size or shape. Travel regions may be geographically determined or determined based on density of geographic data for a region surrounding travel location 650. Travel corridor 701 connects travel location 650 to secondary travel location 651. Travel location 650 may be an airport, and secondary location 651 may be a city located proximate to travel location 650. A detected mode of travel may be an automobile, and because of this travel corridor 701 includes a road 700 and a surrounding geographic region. Geographic data related to the travel corridor may be downloaded.

Geographic areas may have different densities of geographic data. The density of geographic data for a geographic area is based on the amount of geographic data needed to properly describe a geographic region. For example, the density of geographic data may increase as more points of interest are added to a geographic area. The density of geographic data for a geographic area may also be increased as more road data or navigation information is needed to describe a geographic area. For example, a city such as Chicago, Ill. may have a larger geographic data density than a town such as Springfield, Ill. More geographic data is needed to properly describe the geographic areas of Chicago, than is needed to properly describe the geographic areas of Springfield.

A geographic region may be sized based on the density of the geographic data of the geographic areas included in the geographic region. The geographic region may be sized such that amount of geographic data to be downloaded for the geographic region is limited by a maximum allowed amount of data or cap amount of data. Geographic regions with a larger geographic data density may cover a smaller geographic area than geographic regions with a lower geographic data density so that the cap amount of data is not exceeded. Multiple geographic regions may be associated with predicted locations, travel locations, and secondary travel locations.

Geographic region shapes may also be determined based on geographic data density. For example, geographic region 663 may be shaped such that the maximum geographic area may be represented by the geographic region without exceeding the cap amount.

Geographic region shapes and sizes may also be determined based on natural geographic landscapes or any other factor that could influence a geographic region determination.

Secondary travel location 651 is bounded by travel region 661, and includes associated points of interest 670. Travel region 661 may be larger or smaller than travel region 660. For example, travel region 661 may include more points of interest than travel region 660, and therefore the geographic data associated with travel region 661 may be more dense than travel region 660. Geographic data related to travel regions may be sized geographically, or based on mobile device memory capacity.

Travel corridor 703 connects secondary travel location 651 with secondary travel location 652. Secondary travel location 652 is surrounded by travel region 662. Secondary travel location 652 may be a suburb of secondary travel location 651. Secondary travel location 652 may have been determined using a calendar entry indicating a meeting in secondary location 652. Bus transit may be detected as the mode of travel for travel corridor 703, and travel corridor 703 may include a bus route 702, or other bus transit related data.

Travel corridor 704 connects secondary travel location 652 with secondary travel location 653, surrounded by travel region 663. The mode of transportation between secondary location 652 and secondary location 653 may be a transit system, or a train. The geographic data corresponding to travel corridor 704 may then include a transit or train system schedule, or a transit or train system map.

The collection of travel location 650 and secondary travel locations 651-653 may be considered a travel instance. Travel corridors 701, 703 and 704 may also be included in the travel instance. Geographic data relating to travel location 650, secondary travel locations 651-653, and travel corridors 701, 703 and 704 may be downloaded as a travel instance, or may be separately downloaded. That travel location 650 and secondary travel locations 651-653 may each be considered independent travel instances. In such embodiments secondary travel locations 651-653 may be considered travel locations. Any other combination of travel locations and secondary travel locations may be considered a travel instance as well.

While the non-transitory computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS, FTP, SFTP) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and the computer program can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

I claim:

1. A method comprising:
analyzing a memory for indicators of at least one predicted location of a mobile device;
identifying at least one predicted location of a mobile device using the indicators; and
downloading, with a communication interface, geographic data corresponding to the at least one predicted location prior to the arrival of the mobile device at the at least one predicted location.

2. The method of claim 1 wherein indicators of a predicted location comprise an e-mail, a meeting request, a travel itinerary, a flight confirmation, a hotel confirmation, or a rental car confirmation.

3. The method of claim 1 wherein the memory is a local memory of the mobile device.

4. The method of claim 1 wherein the requesting comprises:
identifying a connection to a preferred network; and
downloading the geographic data only when connected to the preferred network.

5. The method of claim 1 wherein identifying the at least one predicted location comprises:
determining an upcoming travel instance; and
determining at least one travel location associated with the travel instance, wherein the at least one travel location is the at least one predicted location.

6. The method of claim 5 further comprising:
identifying a secondary travel location related to the upcoming travel instance; and
determining geographic data related to the secondary travel location.

7. The method of claim 6 wherein the geographic data related to the secondary travel location comprises geographic data related to a detected mode of transportation to the secondary travel location.

8. The method of claim 7 wherein the detected mode of transportation is a transit system, and the geographic data related to the detected mode of transportation comprises a transit system geographic or a transit system schedule.

9. The method of claim 7 wherein the detected mode of transportation is an automobile, and the geographic data comprises geographic data relating to a predicted travel corridor for the automobile.

9. The method of claim 5 wherein the at least one travel location comprises a plurality of travel locations having associated expected travel dates, and wherein the downloading geographic data is prioritized based on a chronological order of the expected travel dates.

11. A non-transitory computer readable medium including instructions that when executed are operable to:
determine an upcoming travel instance;
determine at least one travel location associated with the upcoming travel instance;
determine a travel region associated with the at least one travel location; and
download geographic data to a mobile device corresponding to the travel region prior to a commencement of the upcoming travel instance.

12. The non-transitory computer readable medium of claim 11 wherein the upcoming travel instance is determined by analyzing an e-mail, a meeting request, a travel itinerary, a flight confirmation, a hotel confirmation, or a rental car confirmation.

13. The non-transitory computer readable medium of claim 11 wherein the at least one travel location comprises a plurality of travel locations, the travel locations having corresponding expected travel dates, and wherein the geographic data download is prioritized based on a chronological order of the expected travel dates.

14. The non-transitory computer readable medium of claim 11 wherein the instructions operable to determine at least one travel location comprise instructions to analyze data stored on the mobile device.

15. The non-transitory computer readable medium of claim 11 wherein the instructions are operable to:
identify a preferred network; and
download the geographic data only when connected to the preferred network.

16. An apparatus comprising:
a memory configured to store geographic data;
a communications interface configured to receive data indicating a future travel instance; and
a controller configured to determine the future travel instance from the data indicating the future travel instance, wherein the future travel instance comprises a future travel location; and
wherein the communications interface is further configured to download geographic data corresponding to the future travel location prior to an arrival at the future travel location.

17. The apparatus of claim 16, wherein the data indicating the future travel instance comprises an e-mail, a meeting request, a travel itinerary, a flight confirmation, a hotel confirmation, or a rental car confirmation.

18. The apparatus of claim 16, wherein the controller is further configured to determine a preferred network category, and wherein the communications interface is further configured to receive geographic data corresponding to the future travel location from only the preferred network category.

19. The apparatus of claim 18, wherein the preferred network category comprises a network category selected from the group of: a cellular telephone network, a WiMax network, or a WiFi network.

20. The apparatus of claim 16, wherein the controller is further configured to identify a secondary travel location related to the upcoming travel instance and determine geographic data related to the secondary travel location, and wherein the communications interface is further configured to download the geographic data related to the secondary travel location.
